(19) United States
(12) Patent Application Publication
(10) Pub. No.: US 2024/0284078 A1
(43) Pub. Date: Aug. 22, 2024

(54) Method for generating a customized WRONoC topology

(71) Applicant: AnaGlobe Technology, Inc., Hsinchu (TW)

(72) Inventors: Yan-Lin CHEN, Hsinchu (TW); Wei-Che TSENG, Taipei (TW); Wei-Yao KAO, Taipei (TW); Yao-Wen CHANG, Taipei (TW); Yu-Tsang HSIEH, Hsinchu (TW)

(21) Appl. No.: 18/171,955

(22) Filed: Feb. 21, 2023

(51) Int. Cl. H04Q 11/00

(52) U.S. Cl. CPC H04Q 11/0005; H04Q 2011/0009; H04Q 2011/0043; H04Q 2011/0092

(57) ABSTRACT

A method for generating a customized WRONoC topology is proposed, which is executed by a computer, the method comprising using the computer to perform the following: providing design rules, design specs and a pre-assignment netlist; performing a topology initialization which an initial topology with a minimum number of MRRs is generated according to the netlist; performing a critical path-aware SA optimization to optimize the topology; and performing a wavelength assignment such that the wavelength used by each signal is determined.

### TECHNICAL FIELD

The present invention relates to an optical network-on-chip (ONoC), and more particularly, to a method for generating a customized WRONoC topology.

### BACKGROUND

As technology advances, the requirements for low-latency and power efficient on-chip transmission increases. Traditional electrical interconnects with metal wires incur significant latency growth as the design complexity increases. In contrast, optical interconnects with optical waveguides provide high-speed, low-power, and ultra-high bandwidth communication. Utilizing optical interconnects for on-chip module communication, the optical network-on-chip (ONoC) is considered a promising solution for next-generation System-on-Chip (SoC) designs.

There are two main categories for ONOC designs, the control-network-based ONoCs and the wavelength-routed-based ONoCs (WRONOC). The control-network-based ONoCs require additional arbitration time to route the signals. In contrast, WRONoCs reserve data paths during design time, providing arbitration-free communication with ultra-low signal delay and dynamic control power.

The wavelength-routed optical network-on-chip (WRONoC) is a promising solution for advanced signal communication because of its high-bandwidth, low-latency, and power-efficient signal transmissions. Existing WRONoC topology designs rely on pre-defined network templates that might not accurately capture the device locations and crossing occurrences, leading to inaccurate cost evaluations.

The WRONOC design can be divided into two major stages: topology design and physical design. Topology design determines the logical connections among devices and the wavelengths used by each signal. On the other hand, physical design places optical devices and routes the waveguides considering layout constraints.

These templates might not accurately capture the following features: device locations and crossing occurrences. In physical design, the signal source and target representing the same node should be placed in close positions. However, the network templates in previous work assume that signal sources and targets are placed independently. As a result, the cost of the generated designs might be underestimated. When designing customized topologies to support sparse netlists, many crossings inside the templates are empty without resonators. With no effective method to identify whether these crossings are removable, previous work cannot accurately estimate the number of crossings in the design, incurring inaccurate cost evaluations.

To remedy these disadvantages, this application proposes a general model for WRONoC topologies.

### SUMMARY OF THE INVENTION

To remedy prior art's disadvantage, the invention presents a general model for WRONOC topologies. Based on this model, a method for generating a novel customized WRONOC topology is proposed to minimize the maximum insertion loss and the wavelength and micro-ring resonator (MRR) usage.

In this invention, a method for generating a customized WRONoC topology is proposed, which is executed by a computer, the method comprising using the computer to perform the following: providing design rules, design specs and a pre-assignment netlist stored in a memory for the computer; performing a routing graph construction to generate candidate vias for connections in different wire layers; performing a default path determination to determine signal source and signal target pairs that each default path of a plurality of default paths connects a corresponding signal source and signal target pair; performing a sequence construction to identify each sequence's elements and their order of a set of sequences corresponding to the plurality default paths in a given topology, wherein a sequence is defined to describe order of micro-ring resonators or add-drop filters on each default path; performing a critical path-aware simulated-annealing optimization to minimize maximum insertion loss of all signals and usage of the micro-ring resonators; and performing a wavelength assignment to assign wavelengths to all signals and minimize usage of wavelengths of all signals.

According to one aspect, a communication graph according to required communications is constructed, each vertex specifies a signal source or a signal target, and each edge specifies a signal that connects signal source and signal target. The communication graph is bipartite.

According to another aspect, the method further comprises determining insertion loss of all signals to identify a critical path, wherein a critical path-aware perturbation is adopted to speed up convergence of maximum insertion loss of all signals. The method further comprises estimating crossing numbers and possible crossing locations in the given layout. An initial graph is constructed according to said given topology. The add-drop filters in the given topology are enumerated and redundant micro-ring resonators are removed to calculate number of the micro-ring resonators used. The WRONOC is an actinomorphic symmetric topology for automatic recovery ONoCs or zygomorphic symmetric topology for automatic recovery ONoCs.

In the invention, a non-transitory computer-readable medium containing instructions is proposed, which when read and executed by a computer, cause the computer to execute a method for generating a customized WRONoC topology, wherein the method comprises the above-mentioned steps.

### BRIEF DESCRIPTION OF THE DRAWINGS

The components, characteristics and advantages of the present invention may be understood by the detailed descriptions of the preferred embodiments outlined in the specification and the drawings attached:

FIGS. 1A to 1C show the mechanism of an MRR.

FIG. 2 shows the WDM technique.

FIG. 3 shows five types of transmission losses.

FIGS. 4A to 4C shows the definition of the default path.

FIG. 5A shows three signal paths in a given topology.

FIG. 5B shows a set of sequences corresponding to default paths in a given topology.

FIG. 6 shows a process flow of a method for generating a customized WRONoC topology.

FIG. 7A illustrates the required communications.

FIG. 7B illustrates the constructed communication graph for default path determination.

FIGS. 8A to 8C illustrate signals paths under different circumstances.

FIG. 9A illustrates an Actin-STAR topologies with four nodes.

FIG. 9B illustrates a Zygo-STAR topologies with four nodes.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The invention presents a general model for WRONoC topologies. Based on this model, the invention proposes a novel customized topology design flow to minimize the maximum insertion loss and the wavelength and micro-ring resonator (MRR) usage. Besides, the invention presents two fault-tolerant topologies for full-connectivity netlists, namely the Actin-STAR and Zygo-STAR topologies. The invention proves that the Actin-STAR topology has a performance bound of 2.22 in the primary-path maximum insertion loss, and the Zygo-STAR topology has a performance bound of 1.11 in the backup-path one. Experimental results show that the proposed designs significantly outperform the state-of-the-art designs in wavelength, MRR usage, and the maximum insertion loss. Moreover, it can be extended to represent topologies with any number of devices. Based on this model, it provides effective and flexible design methods for customized and fault-tolerant topologies.

In this invention, the mechanism and design objectives of WRONoCs are introduced.

### WRONOC Mechanism:

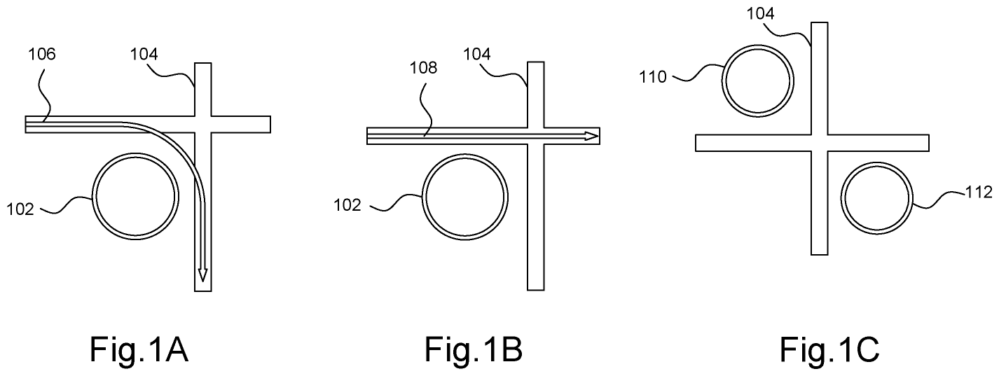

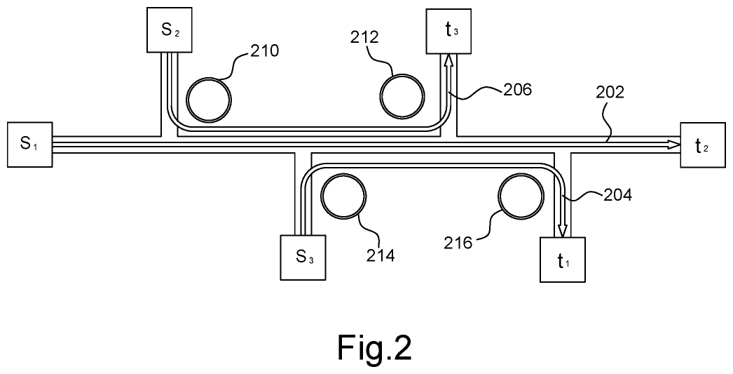

To achieve arbitration-free communication, WRONoCs use a relatively large number of wavelengths for transmission. To accommodate such a large number of wavelengths, the wavelength-division multiplexing (WDM) technique is employed to transmit multiple wavelengths in a single waveguide. Moreover, the microring resonators (MRR) are heavily used to route each signal to its destination. The mechanism of an MRR is illustrated in FIG. 1A˜FIG. 1C. An MRR's resonant wavelengths are the wavelengths that can be coupled with the MRR. Signals transmitted with an MRR's resonant wavelengths will drop to another waveguide when it approaches the MRR. In FIG. 1A, assume that the signal 106 is transmitted with one of the MRR's resonant wavelengths. The signal will activate the MRR 102 and drop to the vertical waveguide 104. In FIG. 1B, assume that the signal 108 is not transmitted with any of the MRR's resonant wavelengths. The signal will maintain its original transmission direction. In FIG. 1C, Two MRRs 110 and 112 can be combined into an add-drop filter (ADF). When a signal transmitted with some MRR's resonant wavelengths approaches the MRR, it activates the MRR and drops to the adjacent waveguide in the crossing. On the other hand, if the signal is not transmitted with the MRR's resonant wavelengths, it will pass through the MRR and maintain its original transmission. Besides, as illustrated in FIG. 1C, two MRRs 110 and 112 can be further combined into an add-drop filter (ADF), where two signal drops can occur in a single waveguide crossing. As shown in FIG. 2, with the WDM technique and MRRs, a WRONOC can reserve dedicated paths for each signal to accomplish arbitration-free communication. In FIG. 2, with the WDM technique, three signals 202, 204 and 206 with different wavelengths can transmit in the same waveguide. Moreover, with the MRRs 210, 212, 214 and 216, each signal can be successfully routed from the source to a target on a dedicated path.

### WRONOC Design Objectives:

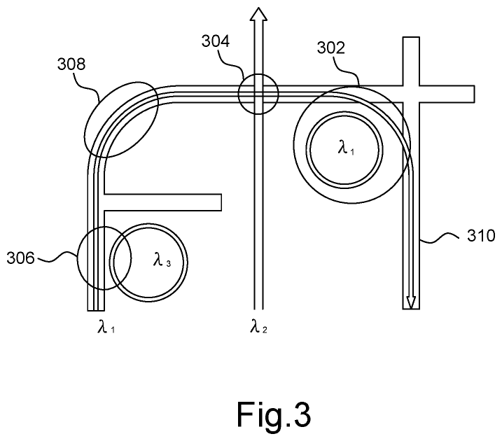

Although WRONoCs provide efficient data transmission, poor designs may still lead to undesired overheads. For example, excessive wavelength usage and poor signal routing can reduce power efficiency. To mitigate these negative impacts, researchers aim to minimize the wavelength and MRR usage and the maximum insertion loss in their WRONOC designs. The insertion loss of a signal consists of the following five types of transmission losses, as shown FIG. 3:

Drop loss 302: The drop loss is incurred when a signal activates an MRR.

Crossing loss 304: When a signal passes through a waveguide crossing.

Through loss 306: When a signal passes through an MRR without activating it.

Bending loss 308: When a signal passes through a bent waveguide.

Path loss 310: When a signal traverses through a waveguide.

The occurrence of bent waveguides and the length of each waveguide highly depend on the placement and routing in the physical design stage. As a result, it shall focus only on minimizing the drop loss, crossing loss, and through loss during topology design.

### Problem Formulation:

The WRONoC topology design problem addressed in this invention can be formulated as follows:

### Problem 1 (WRONoC Topology Design):

Given a WRONoC netlist, generate a WRONoC topology to minimize the maximum insertion loss and the wavelength and MRR usage.

### The Proposed Topology Model:

### Terminologies

The following terminologies and notations in the proposed model are used:

sᵢ∈S is the i-th signal source, where i∈Z⁺ and S is the set of all sources.

tᵢ∈Tis the i-th signal target, where i∈Z⁺ and T is the set of all targets.

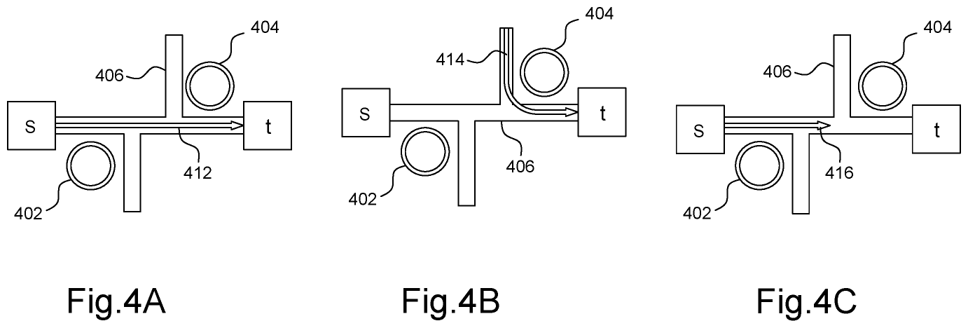

dᵢ∈D is the i-th default path, where i∈Z⁺ and D is the set of all default paths. A default path is a path that satisfies the following transmission characteristics: (1) signals can traverse from one endpoint of the path to another without activating any MRR; (2) signals cannot traverse from any point on the path to some point off the path without activating any MRR; (3) signals cannot traverse from any point off the path to some point on the path without activating any MRR. FIGS. 4A-4C illustrate the definition of the default path.

In FIG. 4A, the specified path 412 is a default path because a signal can traverse from one endpoint to another without activating any MRR 402, 404. In FIG. 4B, the specified path 414 is not a default path since a signal must activate an MRR 404 to traverse the path. In FIG. 4C, the specified path 416 is not a default path since a signal can traverse from any point on the path to t, which is not on the path, without activating any MRR. Signals are transmitted in the waveguide 406.

m_{i,j}^{k} is the k-th MRR that signal (sᵢ, tⱼ) activates, where i, j, k∈Z⁺. In this invention, it assumes that an MRR is activated by only one signal in the netlist.

### Topology Model:

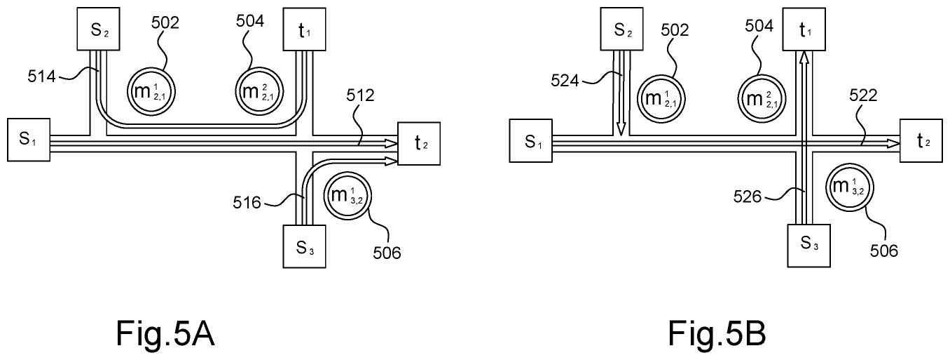

Here, the proposed topology model is introduced. For each default path dᵢ, a sequence [symbol] Mₙⁱ [symbol] is defined to describe the order of MRRs or ADFs on dᵢ. The proposed model is the set of sequences corresponding to all default paths in a given topology. For example, in FIG. 5B, default path d₁ is the path from s₁ to t₂. Signals traversing d₁ will pass through the MRRs 524, 526 and 522 in the order of m_{2,1}¹, m_{2.1}², and m_{3,2}¹. As a result, sequence [symbol] Mₙ¹ [symbol] is defined as [symbol] m_{2,1}¹, m_{2,1}², m_{3,2}¹ [symbol] . After all [symbol] Mₙ¹ [symbol] are defined, the proposed model for the topology in FIG. 5B can be determined as { [symbol] Mₙ¹ [symbol] , [symbol] Mₙ² [symbol] , [symbol] Mₙ³ [symbol] }, wherein sequence [symbol] Mₙ² [symbol] is defined as [symbol] m_{2,1}¹ [symbol] , and sequence [symbol] Mₙ³ [symbol] is defined as [symbol] m_{2,1}¹, m_{2,1}² [symbol] .

In FIG. 5A, it assumes that there are three signals 512, 514 and 516 indicating corresponding paths (s₁, t₂), (s₂, t₁), and (s₃, t₂), in the netlist. The MRRs 502, 504 and 506 can be labeled according to the paths each signal traverses. In FIG. 5B, d₁ is first defined as the path from s₁ to t₂, d₂ as the path starting from s₂, and d₃ as the path from s₃ to t₁. The sequence [symbol] Mₙ¹ [symbol] regarding each default path di can then be determined according to the order of MRRs a signal will pass through when traversing dᵢ.

The proposed model has the following advantages:

The model defines only the connection among devices, which does not incur inaccurate cost estimation.

The model can be extended to describe topologies of any size. The number of sequences and the length of each sequence are not limited. As a result, the model can be extended to represent topologies with any number of nodes, MRRs, and default paths.

The path traversed by any signal (sᵢ, tⱼ) can be easily traced according to the MRRs which (sᵢ, tⱼ) activates and the default paths those MRRs belong to. For example, in FIG. 5B, to trace the path that (s₂, t₁) traverses, we start from d₂, the default path connecting s₂. Next, the elements in sequence [symbol] Mₙ² [symbol] are enumerated to find MRR m_{2,1}¹. Another default path that contains m_{2,1}¹, d₁, is then searched. Afterward, m_{2.1}² is found in [symbol] Mₙ¹ [symbol] behind m_{2,1}¹. This process continues until default path d₃ and target t₁ are found, and the entire path is traced.

### Proposed Algorithms:

In this invention, the method for customized and fault-tolerant topology design is given to demonstrate the applications of the proposed model.

### Customized Topology Design:

### Overview:

Many topologies have been proposed to support full-connectivity netlists [10], [11]. However, for the scenarios in which complete communication is not required, using these fully-connected topologies can be a waste of resources, as some of the devices and waveguides are actually redundant. As a result, in the customized topology design problem, the main objective is to develop topologies with minimized resources to support required communications.

To search for the best topology according to a given netlist, Simulated Annealing (SA) is used to explore the solution space in the proposed topology model. Since searching the whole solution space can be time-consuming, several assumptions are made to focus only on solutions with low MRR usage and small insertion loss.

First, it assumes that each signal will require at most one drop to reach the target. Signals that require two or more drops will pass through more waveguide crossings and MRRs. As a result, this assumption ensures that the generated topologies have a lower insertion loss. Second, it assumes that each default path must connect a source and a target. With this assumption, some signals can be transmitted without activating any MRR, potentially reducing MRR usage and insertion loss. Finally, it assumes that an ADF is the basic building block of a topology. As mentioned above, by utilizing ADFs, two drops can occur in a single waveguide crossing, potentially reducing the number of crossings and the crossing loss for each signal.

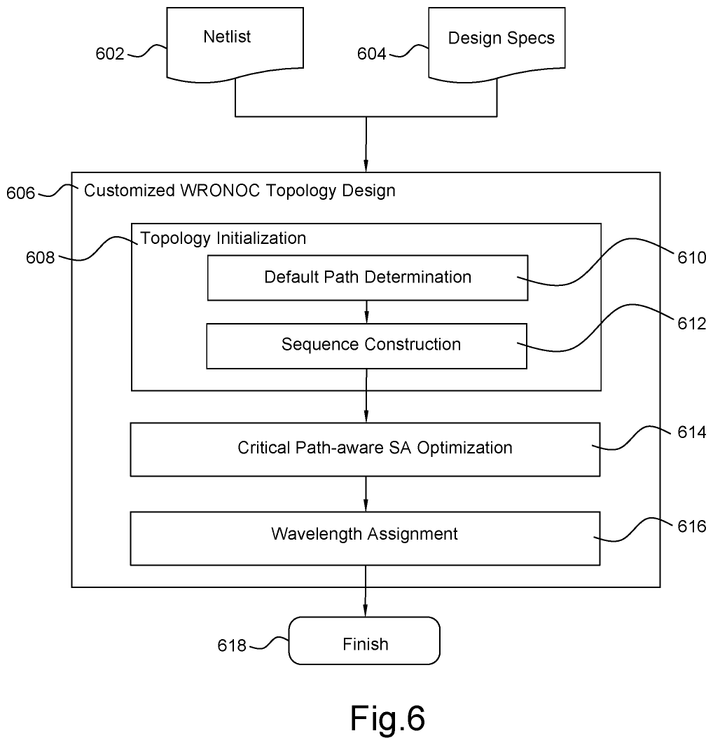

In this invention, an overview of the whole algorithm flow is first given and then detail the proposed method. For example, the netlist may be described in a Simulation Program with Integrated Circuit Emphasis (SPICE) format, and the design constraints are annotated into the netlist. In circuit design, a netlist is a description of the connectivity of an electronic circuit. As shown in FIG. 6, a schematic diagram of a method for generating a customized WRONoC topology is described. FIG. 6 shows the proposed design flow (algorithm flow) for the customized topology design 606. First, a netlist 602 and design specs 604 are provided. Furthermore, the proposed design flow comprises the following three stages: (1) Topology Initialization 608, (2) Critical Path-aware SA Optimization 614, and (3) Wavelength Assignment 616. In Topology Initialization 608, an initial topology with a minimum number of MRRs is generated according to the netlist. In Critical Path-aware SA Optimization 614, SA is used to optimize the topology. In the early stages of annealing, the perturbation is performed only on the critical path to speed up the convergence. Finally, in Wavelength Assignment 616, the wavelength used by each signal is determined. The three stages are detailed in the following sections.

### Topology Initialization:

In this stage of topology initialization 608, the initial topology is constructed for the following optimization stages. To build a topology from scratch with the proposed model, the source/target pair must be determined that each default path connects and each sequence [symbol] Mₙ¹ [symbol] .

The construction of topology initialization 608 is divided into the following two steps: Default Path Determination 610 and Sequence Construction 612.

### Default Path Determination 610:

First, in process of default path determination 610, the source/target pair is determined that each default path connects. Utilizing default paths for transmission has two advantages: (1) MRR usage can be reduced; (2) the insertion loss of the signals using default path transmission can be reduced. Furthermore, it can be guaranteed that MRR usage will be minimal if default path transmission is maximally utilized. Hence, many default paths are used to transmit signals as possible in this step.

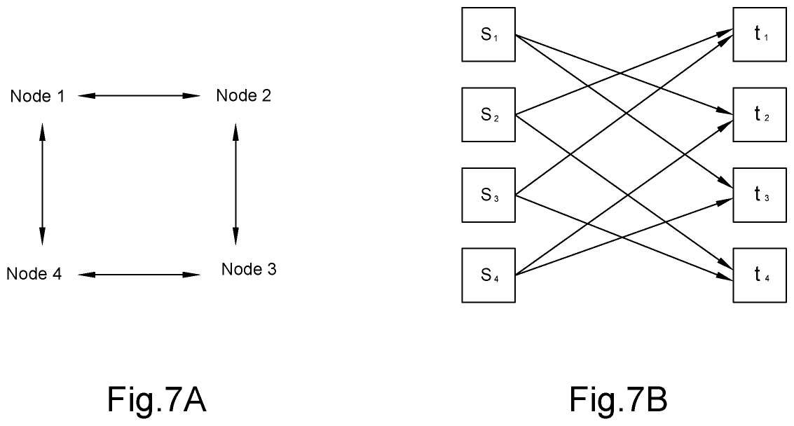

A communication graph according to the required communications is first constructed. On the communication graph, each vertex specifies a source or a target, and each edge specifies a signal that connects the source/target corresponding to the incident vertices. As shown in FIG. 7B, the communication graph is bipartite, with the vertices representing sources on one side and the vertices representing targets on the other. Besides, a source/target can only connect to one default path. In other words, at most one signal transmits from/to a source/target can use default path transmission. As a result, the problem of finding source/target combinations for maximum default path transmission is equivalent to the Maximum Cardinality Bipartite Matching Problem. Classic network flow algorithms, like the Ford-Fulkerson method (refer to: L. R. Ford and D. R. Fulkerson, “Maximal flow through a network,” Can. J. Math., vol. 8, pp. 399-404, 1956), can be applied to solve the problem efficiently. The matched source/target pair can be connected with a default path after solving the problem.

In FIG. 7A, it shows the required communications of node 1, node 2, node 3 and node 4. In FIG. 7B, it shows the constructed communication graph for default path determination. It can be seen that the communication graph is bipartite.

### Sequence Construction 612:

After Default Path Determination 610, in process of sequence construction 612, each sequence's elements and their order are identified. Assume that default path dᵤ connects sᵥ and t_{w}, then any m_{i,j}¹ with i=v or j=w should be included in [symbol] Mₙ^{u} [symbol] . Moreover, as mentioned above, ADFs are used as the basic building blocks of the proposed topology. Therefore, MRRs in a sequence are merged into ADFs. This step creates several redundant MRRs, which will be ignored during cost evaluation. Finally, the order of the ADFs in each sequence is randomly decided.

### Critical Path-Aware SA Optimization 614:

After initialization, in process of critical path-aware SA optimization 614, SA is used to optimize the topology. The main objective of the proposed design flow is to minimize the maximum insertion loss and the wavelength and MRR usage. All objectives are considered in the SA cost function. It details the individual costs and their computing methods as follows:

I is the estimated maximum insertion loss in the topology. To obtain the value of I, the estimated insertion loss of all signals must be first determined to identify the critical path. To calculate the estimated insertion loss of a signal, all transmission losses on the signal path are must be first estimated. As mentioned above, the estimation of the bending loss and path loss are ignored. Since the number of MRR-drops and MRR-throughs can be determined by tracing each signal path, these values are recorded and the drop loss and through loss are directly calculated. As for the crossing loss, poor topology design and complicated structures could incur many crossings in the final layout. Therefore, it is desirable to develop an efficient method to estimate crossing numbers and possible crossing locations in the layout. Modern physical design tools can be employed to minimize crossings to reduce insertion loss (refer to: Y.-K. Chuang, K.-J. Chen, K.-L. Lin, S.-Y. Fang, B. Li, and U. Schlichtmann, “PlanarONoC: Concurrent placement and routing considering crossing minimization for optical networks-on-chip,” in Proc. of DAC, 2018). To imitate this behavior, the crossing minimization algorithm regarding graph drawing is adopted to evaluate the crossing numbers and locations (refer to: C. Gutwenger and P. Mutzel, “An experimental study of crossing minimization heuristics,” in Proc. of GD, 20). An initial graph is first constructed according to the current topology. In the initial graph, the source and target representing the same node are bundled to consider the layout constraint in the physical design stage. The crossing minimization algorithm is then implemented to obtain a new graph, where possible crossing locations are specified. Finally, every signal path is traced to estimate the number of crossings that each signal might pass through, and the crossing loss is calculated.

W is the estimated wavelength usage in the topology. Let G be the set of all waveguides in the topology. For each waveguide g∈G, all signal paths are traced to calculate n_{g}, the number of signals passing through g. To avoid data collision, every signal passing through the same waveguide should use a different wavelength. As a result, max(n_{g}) marks the least number of wavelengths required in the topology. Since max(n_{g}) is positively correlated to the actual wavelength usage, max(n_{g}) is used as the estimated wavelength usage in the SA cost function.

R is the actual MRR usage in the topology. All the ADFs in the topology are enumerated and redundant MRRs are removed to calculate the number of MRRs used.

After the individual costs are determined, the cost of a given topology t in the SA can be calculated by the following cost function:

$$Ψ ( t ) = α {I}^{*} + β {W}^{*} + γ {R}^{*} \qquad ( 1 )$$

where I*, W*, and R* are normalized individual costs, and α, β, and γ are weights of the cost.

Three operations are also developed to perturb a topology to another:

Op1: Swap two neighboring ADFs in a selected sequence.

Op2: Delete an ADF in a sequence and insert it in another location.

Op3: Swap the targets to which two default paths connect.

Op1 and Op2 try to find superior solutions within the same default path setting. In contrast, Op3 searches the solution space using different source/target combinations to form default paths. Besides, since the maximum insertion loss is more difficult to optimize, the critical path-aware perturbation is adopted to speed up the convergence of the maximum insertion loss. In the early stages of SA, the perturbation is performed only on the critical path identified during insertion loss estimation. Thus, elements causing huge insertion loss can be removed early in the optimization process.

### Wavelength Assignment 616:

In the following, the process of wavelength assignment 616 is performed.

After the previous stage, the connections among devices are decided. Here, wavelengths are carefully assigned to prevent data collision. Signals that traverse the same waveguide should be assigned different wavelength.

The ILP method proposed in is applied to assign wavelengths to the signals and minimize wavelength usage (refer to: Y.-S. Lu, Y.-L. Chen, S.-J. Yu, and Y.-W. Chang, “Topological structure and physical layout co-design for wavelength-routed optical networks-on-chip,” IEEE TCAD, vol. 41, no. 7, pp. 2237-2249, 2022). According to the signal paths, a conflict graph is first constructed. In the conflict graph, each vertex specifies a signal, and each edge specifies the following constraint: the two signals corresponding to the incident vertices should not use the same wavelength. Multiple cliques are then identified in the conflict graph according to the waveguide condition. Finally, an improved ILP formulation can be formulated and solved based on the identified cliques.

### Fault-Tolerant Topology Design:

### Overview:

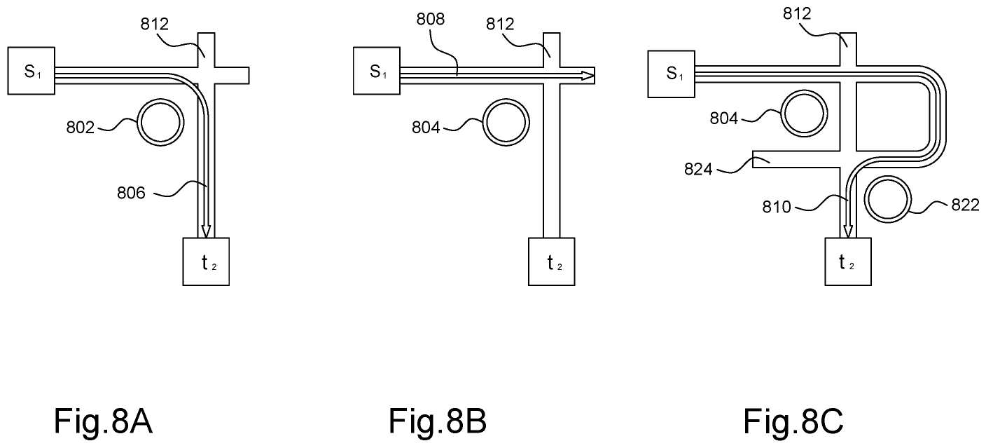

As mentioned above, the arbitration-free communication of WRONoCs relies on the usage of MRRs. However, MRRs are highly susceptible to temperature variations and process variations. Small variations can cause the resonant wavelengths of an MRR to shift, potentially causing transmission failure (refer to: Z. Li, M. Mohamed, X. Chen, E. Dudley, K. Meng, L. Shang, A. R. Mickelson, R. Joseph, M. Vachharajani, B. Schwartz, and Y. Sun, “Reliability modeling and management of nanophotonic on-chip networks,” IEEE TVLSI, vol. 20, no. 1, pp. 98-111, 2012). For example, in FIGS. 8A and 8B, if the resonant wavelength of the MRR shifts due to variations, signal (s₁, t₂) cannot be correctly transmitted to t₂. Signals are transmitted in the waveguide 812. In FIG. 8A, under normal circumstances, signal (s₁, t₂) 806 is correctly transmitted using the normal MRR 802 in the figure. However, in FIG. 8B, if the fault MRR 804 is affected by variations, its resonant wavelengths will shift and (s₁, t₂) can no longer activate the MRR. As a result, the signal 808 cannot be correctly transmitted. In FIG. 8C, by adding additional normal MRR 822 and waveguides 824 to form a backup path, signal (s₁, t₂) has a second chance to transmit to t2.

Fault-tolerant topologies handle this issue and improve network reliability by developing backup paths in the topology. As FIG. 8C shows, the additional MRR and waveguides form a backup path for signal (s₁, t₂), allowing the signal to have a second chance to transmit to the correct destination. The symmetric topology is proposed for automatic recovery (STAR) ONoCs, fault-tolerant topologies, for full-connectivity netlists. The following introduces STAR ONoCs in detail, and proves their performance bound based on the proposed topology model.

### STAR ONoCs:

Based on the invention's architectures, STAR ONoCs can be classified into two categories, the actinomorphic STAR (Actin-STAR) and the zygomorphic STAR (Zygo-STAR) ONoCs. Given a full-connectivity netlist with n nodes (n≥2), the sequence-based model for the corresponding Actin-STAR topology can be determined by defining each Mⱼⁱ, the j-th element in the i-th sequence, as follows:

$${M}_{j}^{i} = \{ \begin{matrix}{a}_{i , {σ}_{i , j , n}}^{1} & if 0 \leq j \leq n - 2 , \\ {a}_{i , {σ}_{i , j , n}}^{2} & if n - 1 \leq j \leq 2 n - 3 ,\end{matrix} \qquad ( 2 )$$

where a_{i,j}¹ denotes an ADF composed of MRRs m_{i,j}¹ and m_{j,i}² and a_{i,j}² denotes an ADF composed of MRRs m_{i,j}² and m_{j,i}¹. Besides, σ_{i,j,n} is defined as follows:

$${σ}_{i , j , n} = \{ \begin{matrix}mod ( i + j , n ) + 1 & if 0 \leq j \leq n - 2 , \\ {σ}_{i , j - n + 1 , n} & if n - 1 \leq j \leq 2 n - 3 ,\end{matrix} \qquad ( 3 )$$

where mod (i, j) denotes the remainder of the division of i by j.

On the other hand, each element Mⱼⁱ in the model for the Zygo-STAR topology is defined as follows:

$${M}_{j}^{i} = \{ \begin{matrix}{z}_{i , {δ}_{i , j , n}}^{1} & if 0 \leq j \leq n - 2 , \\ {z}_{i , {δ}_{i , j , n}}^{2} & if n - 1 \leq j \leq 2 n - 3 ,\end{matrix} \qquad ( 4 )$$

where z_{i,j}^{k} denotes an ADF composed of MRRs m_{i,j}^{k} and m_{j,i}^{k}. Besides, δ_{i,j,n} is defined as follows:

$${δ}_{i , j , n} = \{ \begin{matrix}j + ⌈ \frac{n}{2} ⌉ + 1 & if 0 \leq j \leq ⌊ \frac{n}{2} ⌋ - 1 and 1 \leq i \leq ⌈ \frac{n}{2} ⌉ , \\ n - j & if ⌊ \frac{n}{2} ⌋ \leq j \leq n - i - 1 and 1 \leq i \leq ⌈ \frac{n}{2} ⌉ , \\ n - j - 1 & if n - i \leq j \leq n - 2 and 1 \leq i \leq ⌈ \frac{n}{2} ⌉ , \\ ⌈ \frac{n}{2} ⌉ - j & if 0 \leq j \leq ⌈ \frac{n}{2} ⌉ - 1 and ⌈ \frac{n}{2} ⌉ + 1 \leq i \leq n , \\ j + 1 & if ⌈ \frac{n}{2} ⌉ \leq j \leq i - 2 and ⌈ \frac{n}{2} ⌉ + 1 \leq i \leq n , \\ j + 2 & if i - 1 \leq j \leq n - 2 and ⌈ \frac{n}{2} ⌉ + 1 \leq i \leq n , \\ {δ}_{i , 2 n - 3 - j , n} & if n - 1 \leq j \leq 2 n - 3.\end{matrix} \qquad ( 5 )$$

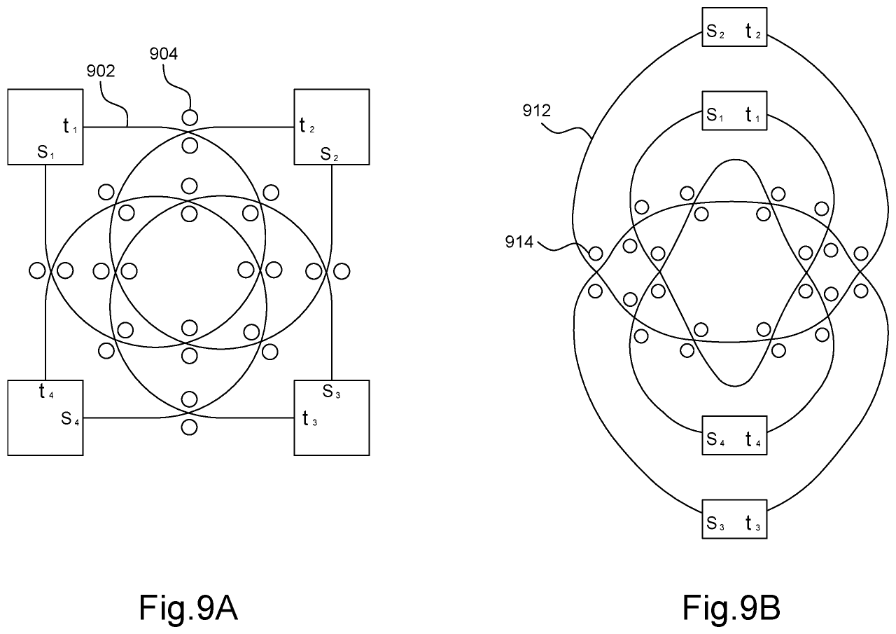

In both topologies, default path di connects sᵢ and tᵢ. Besides, the MRR indices are set so that in both topologies, the primary path of (sᵢ, tⱼ) consists of waveguides between sᵢ and m_{i,j}ⁱ and waveguides between m_{i,j}¹ and tⱼ. On the other hand, the backup path for signal (sᵢ, tⱼ) is composed of waveguides between sᵢ and m_{i,j}² and waveguides between m_{i,j}² and tⱼ. FIGS. 9A and 9B illustrate an Actin-STAR and a Zygo-STAR topologies with four nodes, respectively.

As suggested by the “automatic recovery” in its name, STAR ONoCs are fault-tolerant. Since for any two nodes, their corresponding default paths cross each other with ADFs twice. Consequently, there is an alternative ADF switching the corresponding signals between these two paths when the primary ADF fails. Besides fault tolerance, STAR ONoCs also have the following advantages. First, STAR ONoCs are planar, meaning that they can be drawn so that no empty crossings exist. By eliminating redundant crossings outside ADFs, insertion loss can be further reduced. Secondly, STAR ONoCs are planar even if the source and target of the same node are bundled together. Thus, the uncertainty in the physical design stage can be reduced. Finally, STAR ONoCs use the minimum number of MRRs without using MRR's multi-wavelength property mentioned in (refer to: Y.-K. Chuang, Y. Zhong, Y.-H. Cheng, B.-Y. Yu, S.-Y. Fang, B. Li, and U. Schlichtmann, “RobustONoC: Fault-tolerant optical networks-on-chip with path backup and signal reflection,” in Proc. of ISQED, 2021). For any signal not using default path transmission, at least two unique MRRs are required to construct a primary path and a backup one. Therefore, given n nodes and a full-connectivity netlist, the minimum MRR usage for a fault-tolerant topology is 2n(n−1), which is exactly the same as in a STAR ONOC. With these advantages, STAR ONoCs have the potential to achieve lower insertion loss.

### Performance Bound of STAR ONoCs:

Actin-STAR and Zygo-STAR are designed to favor insertion loss on different paths. Actin-STAR reduces the maximum insertion loss on the primary path by sacrificing that on the backup path. On the other hand, Zygo-STAR tends to balance the maximum insertion loss on both primary and backup paths, bounding the maximum backup-path insertion loss in case of MRR failures. Here, the performance bound for Actin-STAR and Zygo-STAR is proved.

Some notations are first specified:

n: the number of nodes.

L_{d}: the drop loss induced by a single MRR-drop.

L_{c}: the crossing loss induced by a single crossing.

Lₜ: the through loss induced by a single MRR-through.

Iₚ(t): the maximum primary-path insertion loss of topology t.

I_{b}(t): the maximum backup-path insertion loss of topology t.

### Theorem 1:

The ratio of Actin-STAR's maximum primary-path insertion loss to the optimal value is less than or equals (2L_{c}+4Lₜ)/(L_{c}+Lₜ).

### Proof 1:

As indicated in the sequence-based model, a primary path passes at most (2n−4) ADFs in Actin-STAR. Thus, there are (2n−4) crossings, (4n−8) MRR-throughs, and 1 MRR-drop in the maximum primary-path insertion loss. As for the optimal value, signals must drop from the source one by one, so the maximum primary-path insertion loss occurs at the last signal that drops from the source. In addition, there may be crossings without MRRs. Thus, there are (n−2) MRR-throughs, 1 MRR-drop, and at least (n−2) crossings in the maximum primary-path insertion loss. Consequently, the ratio of Actin-STAR's maximum primary-path insertion loss to the optimal value is given by

$$\frac{{I}_{p} ( {t}_{actin} )}{{I}_{p} ( {t}_{p}^{*} )} \leq \frac{{L}_{d} + ( 2 n - 4 ) {L}_{c} + ( 4 n - 8 ) {L}_{t}}{{L}_{d} + ( n - 2 ) {L}_{c} + ( n - 2 ) {L}_{t}} , \qquad ( 6 )$$

where t_{actin} is the Actin-STAR topology and t′ₚ is the topology with the optimal maximum primary-path insertion loss. Since this ratio grows with n for n≥2, the performance bound can be obtained by computing the limit of the ratio as n approaches infinity as follows:

$${lim}_{n \to ∞} \frac{{I}_{p} ( {t}_{actin} )}{{I}_{p} ( {t}_{p}^{*} )} \leq \frac{2 {L}_{c} + 4 {L}_{t}}{{L}_{c} + {L}_{t}} . \qquad ( 7 )$$

By setting the transmission losses as in, L_{c}=0.04 dB and Lₜ=0.005 dB, a performance bound of 2.22 can be obtained (refer to: M. Xiao, T.-M. Tseng, and U. Schlichtmann, “FAST: A fast automatic sweeping topology customization method for application-specific wavelength-routed optical NoCs,” in Proc. of DATE, 2021).

### Theorem 2:

The ratio of Zygo-STAR's maximum backup-path insertion loss to the optimal value is less than or equals (L_{c}+2Lₜ)/(L_{c}+Lₜ).

### Proof 2:

As indicated in the sequence-based model, a backup path passes at most (2n−2) ADFs in Zygo-STAR. Thus, there are (2n−2) crossings, (4n−4) MRR-throughs, and 1 MRR-drop in the maximum backup-path insertion loss. As for the optimal value, besides going through all primary MRRs, the signal with the maximum backup-path insertion loss also goes through all other backup MRRs. In addition, there may be crossings without MRRs. Thus, there are (2n−3) MRR-throughs, 1 MRR-drop, and at least (2n−3) crossings in the maximum backup-path insertion loss. Consequently, the ratio of Zygo-STAR's maximum backup-path insertion loss to the optimal value is given by:

$$\frac{{I}_{b} ( {t}_{zygo} )}{{I}_{b} ( {t}_{b}^{*} )} \leq \frac{{L}_{d} + ( 2 n - 2 ) {L}_{c} + ( 4 n - 4 ) {L}_{t}}{{L}_{d} + ( 2 n - 3 ) {L}_{c} + ( 2 n - 3 ) {L}_{t}} , \qquad ( 8 )$$

where t_{zygo} is the Zygo-STAR topology and t′_{b} is the topology with the optimal maximum backup-path insertion loss. The performance bound can also be obtained by computing the limit of the ratio as n approaches infinity as follows:

$${lim}_{n \to ∞} \frac{{I}_{b} ( {t}_{zygo} )}{{I}_{b} ( {t}_{b}^{*} )} \leq \frac{{L}_{c} + 4 {L}_{t}}{{L}_{c} + {L}_{t}} . \qquad ( 9 )$$

Again, by setting the transmission losses, a performance bound of 1.11 can be obtained.

### Experimental Results:

To evaluate the effectiveness and efficiency of the proposed work, two experiments are conducted. The experiments were performed on an AMD Ryzen 2.9 GHZ workstation with 128 GB memory in the C++ programming language. For the crossing minimization algorithm in the SA optimization stage, the crossing minimization module in the Open Graph Drawing Framework is adopted (refer to: M. Chimani, C. Gutwenger, M. Junger, G. W. Klau, K. Klein, and P. Mutzel, “The open graph drawing framework (ogdf).” Handbook of graph drawing and visualization, vol. 2011, pp. 543-569, 2013). As for the ILP method in the wavelength assignment stage, the Gurobi Optimizer is used (refer to: Gurobi optimizer reference manual, Gurobi Optimization, Inc., 2018. [Online]. Available: http://www.gurobi.com) as the proposed ILP solver. Besides, the transmission losses are set according to the settings: 0.5 dB per drop, 0.04 dB per cross, and 0.005 dB per through.

In the first experiment, the proposed method is evaluated for customized topologies by comparing it with FAST based on their benchmarks. For topologies not planar with bundled sources and targets, evaluation on a different model or template may result in different insertion loss values. Therefore, for a fair comparison, we first re-implemented PlanarONoC, the state-of-the-art physical design tool for ONoC design. Then, the generated topologies are evaluated after PlanarONoC produced their layouts. As shown in Table I and Table II, the proposed work averagely achieved a 17.9% reduction in MRR usage and a 16.1% reduction in maximum insertion loss in a reasonable computation time.

TABLE I

| | | | FAST | | Ours | |
|---|---|---|---|---|---|---|
| Benchmark | #Node | #Path | #MRR | #WL | #MRR | #WL |
| Case1 | 8 | 44 | 36 | 7 | 36 | 7 |
| Case2 | 12 | 26 | 24 | 7 | 20 | 7 |
| Case3 | 12 | 20 | 14 | 5 | 10 | 5 |
| Case4 | 16 | 22 | 19 | 7 | 11 | 7 |
| Case5 | 8 | 48 | 40 | 6 | 40 | 6 |
| Case6 | 8 | 24 | 20 | 6 | 20 | 6 |
| Case7 | 8 | 24 | 24 | 6 | 20 | 6 |
| Comp. | — | — | 1.22 | 1.00 | 1.00 | 1.00 |

TABLE II

| | |
|---|---|
| FAST | Ours |

| | Max. | Time | Max. | Time |
|---|---|---|---|---|
| Benchmark | IL (dB) | (s) | IL (dB) | (s) |
| Case1 | 7.18 | 0.04 | 6.61 | 115 |
| Case2 | 10.83 | 1.25 | 7.17 | 81 |
| Case3 | 6.52 | 1.65 | 5.71 | 43 |
| Case4 | 7.44 | 1.50 | 6.28 | 27 |
| Case5 | 7.78 | 0.04 | 6.55 | 102 |
| Case6 | 4.79 | 0.31 | 4.39 | 11 |
| Case7 | 6.12 | 0.03 | 5.36 | 33 |
| Comp. | 1.19 | 0.02 | 1.00 | 1.00 |

In the second experiment, STAR ONoCs is evaluated by comparing them with the fault-tolerant topologies reported in RobustONoC (refer to: Y.-K. Chuang, Y. Zhong, Y.-H. Cheng, B.-Y. Yu, S.-Y. Fang, B. Li, and U. Schlichtmann, mentioned above). Since all topologies are planar with the source and target of the same node bundled together, the topologies are directly compared without generating their layouts with PlanarONoC. As shown in Table III, ActinSTAR averagely achieved a 39.8% reduction in wavelength usage, a 19.8% reduction in maximum primary-path insertion loss, and a 36.6% reduction in maximum backup-path insertion loss with an 11.6% MRR usage overhead. Besides, Zygo-STAR averagely achieved a 39.8% reduction in wavelength usage, a 7.5% reduction in maximum primary-path insertion loss, and a 50.7% reduction in maximum backup-path insertion loss with an 11.6% MRR usage overhead. The superior MRR usage in RobustONoC results from using MRR's multi-wavelength resonance property. However, the utilization also results in massive overheads on wavelength usage and insertion loss. Consequently, the proposed work significantly outperforms RobustONoC in those metrics.

TABLE III

| | | | | P. Max | B. Max |
|---|---|---|---|---|---|
| #Node | Topology | #MRR | #WL | IL (dB) | IL (dB) |
| 4 | RobustONoC | 25 | 8 | 0.950 | 1.775 |
| | Actin-STAR | 24 | 7 | 0.700 | 1.000 |
| | Zygo-STAR | 24 | 7 | 0.800 | 0.800 |
| 6 | RobustONoC | 36 | 24 | 1.025 | 1.935 |
| | Actin-STAR | 48 | 11 | 0.900 | 1.400 |
| | Zygo-STAR | 48 | 11 | 1.050 | 1.050 |

In the invention, a general model for WRONoC topologies is proposed. With this model, an SA-based design flow for customized topologies is proposed. We have also presented two fault-tolerant topologies for full connectivity netlists, namely the Actin-STAR and Zygo-STAR topologies. It has proven that the Actin-STAR topology has a performance bound of 2.22 in the maximum primary-path insertion loss, and the Zygo-STAR topology has a performance bound of 1.11 in the backup-path one. Experimental results have shown that the proposed method is superior to the existing design flow.

The invention's contributions are summarized as follows:

(1) The invention proposes a general model for WRONOC topologies. This model provides a concise data structure for accurate cost evaluations in later stages. Moreover, it can be extended to represent topologies with any number of devices.

(2) With the proposed topology model, it proposes a simulated-annealing (SA) based design flow for customized topology design.

(3) The invention presents two fault-tolerant topologies for full-connectivity netlists, namely the Actin-STAR and Zygo-STAR topologies. It proves that the Actin-STAR topology has a performance bound of 2.22 in the maximum primary-path insertion loss, and the Zygo-STAR topology has a performance bound of 1.11 in the backup-path one.

(4) Experimental results show that the proposed design flow for customized topologies can achieve a 17.9% MRR usage reduction and a 16.1% maximum insertion loss reduction compared with FAST.

(5) Experimental results also show that the proposed STAR ONoCs significantly outperform the Robust ONOC topology in wavelength, the maximum primary-path insertion loss, and the maximum backup-path insertion loss.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A non-transitory computer-readable medium containing instructions, which when read and executed by a computer, cause the computer to execute a method for generating a customized WRONOC topology, wherein the method comprises steps of:
performing a default path determination to determine signal source and signal target pairs that each default path of a plurality of default paths connects a corresponding signal source and signal target pair;
performing a sequence construction to identify each sequence's elements and their order of a set of sequences corresponding to said plurality default paths in a given topology, wherein a sequence is defined to describe order of micro-ring resonators or add-drop filters on said each default path;
performing a critical path-aware simulated-annealing optimization to minimize maximum insertion loss of all signals and usage of said micro-ring resonators; and
performing a wavelength assignment to assign wavelengths to said all signals and minimize usage of wavelengths of said all signals.

2. The non-transitory computer-readable medium of claim 1, wherein a communication graph according to required communications is constructed, each vertex specifies a signal source or a signal target, and each edge specifies a signal that connects said signal source and said signal target.

3. The non-transitory computer-readable medium of claim 2, wherein said communication graph is bipartite.

4. The non-transitory computer-readable medium of claim 1, further comprising determining said insertion loss of said all signals to identify a critical path.

5. The non-transitory computer-readable medium of claim 4, wherein a critical path-aware perturbation is adopted to speed up convergence of said maximum insertion loss of said all signals.

6. The non-transitory computer-readable medium of claim 1, further comprising estimating crossing numbers and possible crossing locations in said given layout.

7. The non-transitory computer-readable medium of claim 1, wherein an initial graph is constructed according to said given topology.

8. The non-transitory computer-readable medium of claim 1, wherein said add-drop filters in said given topology are enumerated and redundant micro-ring resonators are removed to calculate number of said micro-ring resonators used.

9. The non-transitory computer-readable medium of claim 1, wherein said WRONoC is an actinomorphic symmetric topology for automatic recovery ONoCs.

10. The non-transitory computer-readable medium of claim 1, wherein said WRONoC is a zygomorphic symmetric topology for automatic recovery ONoCs.

11. A method for generating a customized WRONoC topology, which is executed by a computer, the method comprising:
using the computer to perform the following:
performing a routing graph construction to determine signal source and signal target pairs that each default path of a plurality of default paths connects a corresponding signal source and signal target pair;
performing a sequence construction to identify each sequence's elements and their order of a set of sequences corresponding to said plurality default paths in a given topology, for said each default path, wherein a sequence is defined to describe order of micro-ring resonators or add-drop filters on said each default path;
performing a critical path-aware simulated-annealing optimization to minimize maximum insertion loss of all signals and usage of said micro-ring resonators; and
performing a wavelength assignment to assign wavelengths to said all signals and minimize usage of wavelengths of said all signals.

12. The method of claim 11, wherein a communication graph according to required communications is constructed, each vertex specifies a signal source or a signal target, and each edge specifies a signal that connects said signal source and said signal target.

13. The method of claim 12, wherein said communication graph is bipartite.

14. The method of claim 11, further comprising determining said insertion loss of said all signals to identify a critical path.

15. The method of claim 14, wherein a critical path-aware perturbation is adopted to speed up convergence of said maximum insertion loss of said all signals.

16. The method of claim 11, further comprising estimating crossing numbers and possible crossing locations in said given layout.

17. The method of claim 11, wherein an initial graph is constructed according to said given topology.

18. The method of claim 11, wherein said add-drop filters in said given topology are enumerated and redundant micro-ring resonators are removed to calculate number of said micro-ring resonators used.

19. The method of claim 11, wherein said WRONoC is an actinomorphic symmetric topology for automatic recovery ONoCs.

20. The method of claim 11, wherein said WRONoC is a zygomorphic symmetric topology for automatic recovery ONoCs.
